(19) United States
(12) Patent Application Publication
(10) Pub. No.: US 2020/0337293 A1
(43) Pub. Date: Oct. 29, 2020

(54) BAIT BOX WITH LOCKING BAIT BAR

(71) Applicant: Ecolab USA Inc., Saint Paul, MN (US)

(72) Inventors: Alexander Roy Nee, Eagan, MN (US); Jason David Hedlund, Lake Elmo, MN (US); Kenneth Thomas Dobizl, Mounds View, MN (US)

(21) Appl. No.: 16/857,142

(22) Filed: Apr. 23, 2020

Related U.S. Application Data
(60) Provisional application No. 62/837,597, filed on Apr. 23, 2019.

(51) Int. Cl. A01M 23/16; A01M 1/02

(52) U.S. Cl. CPC A01M 23/16; A01M 1/02

(57) ABSTRACT

A pest control device may include a bait support system. The bait support system may include a bait bar having a first end and a second end. An aperture in the pest control device may receive at least a portion of the first end of the bait bar. A locking mechanism may secure the second end so as to lock the bait bar to the pest control device. The bait bar may be locked to the pest control device when a lid of the pest control device is in an open configuration.

### CLAIM OF PRIORITY

This patent application claims the benefit of priority of U.S. Provisional Patent Application Ser. No. 62/837,597, entitled “BAIT BOX WITH LOCKING BAIT BAR,” filed on Apr. 23, 2019 (Attorney Docket No. 4897.015PRV), which is hereby incorporated by reference herein in its entirety.

### TECHNICAL FIELD

This document pertains generally, but not by way of limitation, to a pest control device.

### BACKGROUND

A pest control device may include a bar for supporting bait (e.g., a block of rodenticide, including, but not limited to, bromadiolone or the like). Prior pest control devices may have used a lid to lock the bait bar in place which is holding the bait, so that the bait cannot be removed from the device. When the lid is opened the bait bar is released to allow bait to be removed from and/or replaced on the bar. However, in some cases, the lid may not be closed sufficiently to keep the bait bar in position, which may result in bait being freed from the bar holding it. In some cases, an animal may open the pest control device, thereby freeing the bait bar and the bait. In some cases, the bait bar is not positioned adequately and the bait can be stripped from the bait bar. What is needed in the art is a better way to secure bait in pest control devices, such that the bait bar is locked in place for instance even if the cover of the bait box is open. The present subject matter addresses these and other problems with prior art pest control devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of an example of a pest control device according to one embodiment of the present subject matter.

FIG. 2 illustrates a detailed perspective view of an example of a bait locking device for one bait support system according to one embodiment of the present subject matter.

### OVERVIEW

The present inventors have recognized, among other things, that a problem to be solved includes securing bait within a bait bar inside of a pest control device. Another problem to be solved includes preventing the unintended separation of the bait from the pest control device regardless of whether the cover is open or closed.

The present subject matter can help provide a solution to these and other problems, such as by providing a bait support system. The bait support system may include a bait bar having a first end and a second end. The bait support system may include an aperture or receptacle that may be configured to receive at least a portion of the first end of the bait bar. The bait support system may include a locking mechanism at the other end. The locking mechanism may be configured to secure the second end of the bait bar so as to lock the bait bar to the pest control device and keep the baits on the bar even if the pest control device is open.

The bait support system may secure the bait bar inside of the pest control device and help inhibit the unintended separation of the bait from the pest control device. For example, the locking mechanism may require a user to disengage the bait bar from the locking mechanism in order to remove the bait bar from the pest control device. Accordingly, securing the bait bar with the locking mechanism inhibits separation of the bait from the bait bar, and from the pest control device. This overview is intended to provide an overview of subject matter of the present patent application. It is not intended to provide an exclusive or exhaustive explanation of the invention. The detailed description is included to provide further information about the present patent application.

### DETAILED DESCRIPTION

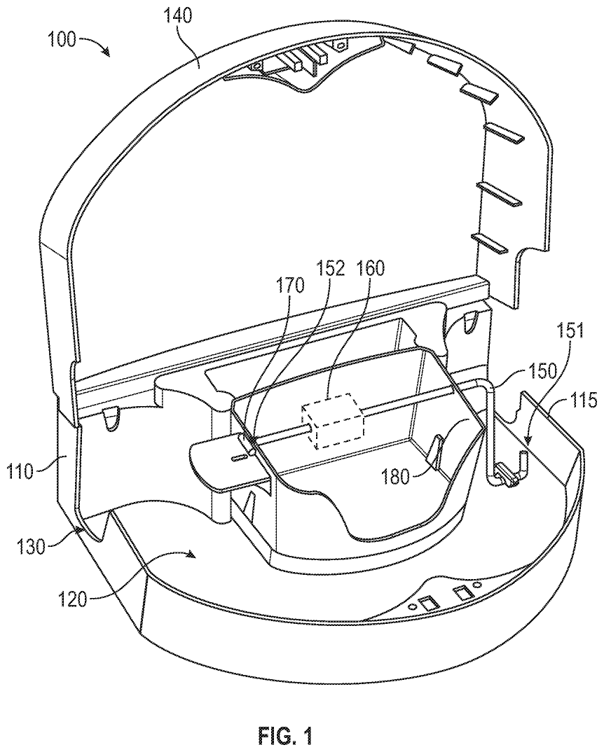

FIG. 1 illustrates a perspective view of an example of a pest control device 100 according to one embodiment of the present subject matter. The pest control device 100 may include a device chassis 110. The chassis 110 may define a pest control area 120. The chassis 110 may be sized and shaped to allow a pest (e.g., a rodent, insect, or the like) to access the pest control area 120. For example, the chassis 110 may define an access port 130. The port 140 can provide access to an interior of the chassis 110 (or egress from the interior of the chassis 110). In various embodiments, the chassis 110 is made of materials including, but not limited to, wood, metal, plastic, or combinations thereof. In various embodiments the chassis a molded polymer design.

The pest control device 100 may include a lid 140. The lid 140 may allow a user to access the pest control area 120. The lid 140 may include an open configuration (as shown in FIG. 1). The lid 140 may include a closed configuration where the lid is coupled to a lip 115 of the chassis 110 to reduce access to the pest control area 120. With the lid 140 in the closed configuration, the pest control area 120 may be accessible (e.g., by a pest) through the access port 130.

The pest control device 100 may include a bait bar 150, and the bait bar 150 may be located in the pest control area 120. The bait bar 150 may support bait 160 (e.g., a block of rodenticide). For example, the bait bar 150 may be inserted into the bait 160, and the bait 160 may be suspended from the bait bar 150 within the pest control area 120. In various embodiments, the bait bar 150 is made of metal; however, other materials may be used.

The bait 160 may be used to detect the presence of, or control the population of, a pest. The pest control device 100 may be located within a structure (e.g., a home, office building, warehouse, commercial space, municipal building, shed, garage, or the like). The pest control device 100 may be located proximate to the structure (e.g., located proximate to an exterior of the structure). The pest control device 100 may be located in an open area (e.g., a yard, field, farm land, wooded area, or the like). The pest control device 160 may include a trap (e.g., a snap trap, or the like) to catch (or kill) a pest.

In some approaches, the lid 140 may be configured to lock the bait bar 150 within the pest control area 120. For example, in the closed configuration the lid 140 may clamp down on the bait bar 150 or secure the bait bar 150 within the pest control area 120. With the lid 140 in the open configuration, the bait bar 150 may be removed from the pest control area 120.

The pest control device 100 may include a bait bar receptacle 170 (e.g., a socket, pocket, port, anchor point, or the like). For instance, the chassis 110 may define the bait bar receptacle 170. The bait bar receptacle 170 may receive a portion of the bait bar 150. The bait bar receptacle 170 may retain a portion of the bait bar 150. For example, the bait bar receptacle 170 may receive a first end 151 of the bait rod 150, and the first end 151 may be retained in the receptacle 170, for instance to secure the bait bar 150 from the chassis 110.

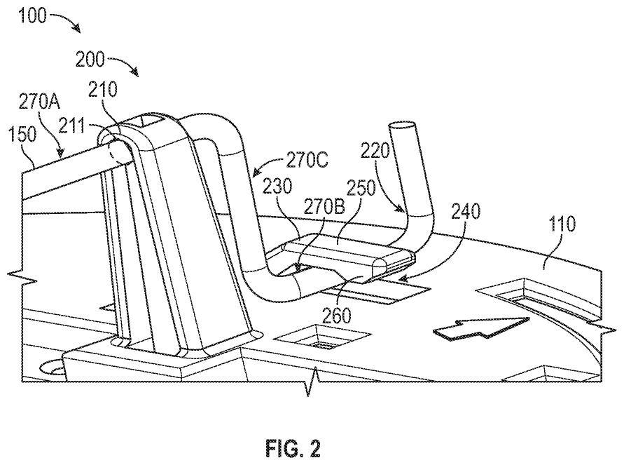

The pest control device 100 may include a post 180 (e.g., a wall, protrusion, finger, boss, or the like), and the post 180 may support (or retain) the bait bar 150. For example, post 180 may support the first end 151 of the bait bar 150 (or the bait supporting section 270A, shown in FIG. 2). The bait bar receptacle 170 may support the second end 152 of the bait bar 150. Accordingly, the bait bar 150 may extend between the bait bar receptacle 170 and the post 180.

FIG. 2 is a detailed perspective view of an example of a bait support system 200 according to one embodiment of the present subject matter. The bait support system 200 may be included in the pest control device 100. The bait support system 200 may secure the bait rod 150 to the chassis 110. The bait support system 200 may secure the bait rod 150 to the chassis 110 when the lid 140 (e.g., as shown in FIG. 1) is in the open configuration. Accordingly, the bait support system 200 may secure the bait 160 (e.g., as shown in FIG. 1) within the pest control area 120 (e.g., as shown in FIG. 1) and prevent the unintended separation of the bait 160 from the pest control device 100.

The bait support system 200 may include a post 210. The post 210 may project from the chassis 110. The bait rod 150 may engage with the post 210 to secure the bait to the chassis 110. As described herein, the bait rod 150 may include a first end 151 and a second end 152 (shown in FIG. 1). The second end 152 can be inserted into the post 210. For instance, a portion of the bait rod 150 may be received by an aperture 211 defined by the post 210. Although FIG. 2 shows the second end extending through the post 210, the present subject matter is not so limited. For instance, the post 210 may capture the second end within a receptacle. The post 210 may help elevate the bait 160 with respect to the chassis 110.

The reception of the bait bar 150 by the aperture 211 of the post 210 may facilitate securing the bait bar 150 to the chassis 110. For example, the bait bar 150 may be slidably coupled to the post 210 when the bait bar 150 is received in the aperture 211. Securing the bait par 150 to the chassis 110 may include inhibiting the separation of the bait bar 150 from the post 150. For instance, the slidable coupling of the bait bar 150 with the post 210 may inhibit separation of the bait bar 150 from the post 210 when the bait bar 150 is received in the aperture 211. Accordingly, the post 210 facilitates securing the bait bar 150 to the chassis 110. The post 210 may cooperate with the bait bar receptacle 170 and a locking mechanism 230 to secure the bait bar 150 to the chassis 110.

The bait rod 150 may define a hook portion 220, and the chassis 110 may define the locking mechanism 230. The hook portion 220 may be located at the first end of the bait rod 150. The hook portion 220 may engage with the locking mechanism 230 (e.g., clip, latch, detent, recess, or the like) to secure the bait rod 150 to the chassis 110. For example, the locking mechanism 230 may be sized and shaped to receive the hook portion 220 of the bait rod 150, and the reception of the hook portion 220 by the locking mechanism 230 may inhibit the movement of the bait rod 150 with respect to the chassis 110 (and the post 210). Accordingly, the bait rod 150 may be secured to the chassis 110 to inhibit separation of the bait from the chassis 110 (or to inhibit separation of the bait rod 150 from the chassis 110).

In various embodiments, the locking mechanism 230 is a metal part that attaches to the chassis 110. In various embodiments, the locking mechanism 230 is a plastic part that attaches to the chassis 110. In various embodiments, the locking mechanism 230 is a molded component of the chassis 110.

As described herein, the bait support system 200 may include the bait rod 150 that has the hook portion 220, and a locking mechanism 230. The locking mechanism 230 may be sized and shaped to receive the hook portion 220. For example, the locking mechanism 230 may define a locking channel 240 that may be sized and shaped to receive the hook portion 220. The locking channel 240 can be defined by a tab 250 that projects from the chassis 110. The reception of the hook portion 220 within the locking channel 240 may secure the bait rod 150 to the chassis 110, and may inhibit the movement (e.g., removal) of the bait rod 150 with respect to the chassis 110. Securing the bait rod 150 to the chassis 110 may inhibit the unintended separation of the bait 160 (e.g., as shown in FIG. 1) from the chassis 110 (e.g., if an animal interacts with the bait rod 150 in an attempt to separate the bait 160 from the chassis 110). Accordingly, securing the bait rod 150 to the chassis 110 improves the performance of the pest control device 100 because the bait 160 may remain available for additional pests to consume the bait.

In an example, the bait bar 150 is configured to pivot with respect to the chassis 110. Pivoting the bait bar 150 with respect to the chassis 110 may transition the bait support system 200 between a locked configuration and an unlocked configuration. For instance, the bait bar 150 may be slidably coupled with the post 210 (and thereby facilitate securing the bait bar 150 to the chassis 110). The slideable coupling of the bait bar 150 with the post 210 may allow the bait bar 150 to pivot with respect to the post 210 (e.g., the bait bar 150 rotates within the aperture 211). Pivoting of the bait bar 150 may facilitate the reception of the hook portion 220 by the locking mechanism 230 (or disengagement of the hook portion 220 from the locking mechanism 230). For example, in the locked configuration, the bait bar 150 is rotated to locate the hook portion 220 in the locking channel 240 of the locking mechanism 230. The bait bar 150 may be rotated, and the hook portion 220 may be disengaged from the locking channel 240 to transition the bait support system 200 to the unlocked configuration. Accordingly, pivoting (or other movement) of the bait rod 150 may facilitate transitioning the bait support system 200 between the locked configuration and the unlocked configuration. In an example, in the unlocked configuration, the bait bar 150 is allowed to move relative to the chassis 110.

In various embodiments, the post 210 is a metal part that attaches to the chassis 110. In various embodiments, the post 210 is a plastic part that attaches to the chassis 110. In various embodiments, the post 210 is a molded component of the chassis 110. In various embodiments the post 210 has a hole for the bait bar 150 to pass through. In various embodiments the post 210 has a slot instead of a hole to allow the bait bar 150 to be removed more easily in its unlocked configuration, but which secures the bait bar 150 when in the locked configuration.

In some examples, the locking mechanism 230 may define a ridge 260. The ridge 260 may engage with the hook portion 220 of the bait rod 150 to inhibit movement of the hook portion 220 out of the locking channel 240. Accordingly, the ridge 260 may help improve the coupling of the bait rod 150 with the chassis 110 by increasing the amount of force necessary to remove the bait rod 150 from the locking channel 240.

For instance, the bait bar 150 may include one or more sections 270 such as bait supporting section 270A, a locking section 270B, and a transition section 270C. The bait supporting section 270A may support the bait 160 (shown in FIG. 1). For example, the bait bar 150 may support the bait 160 in a location between the post 210 and the bait bar receptacle 170. The locking section 270B may be parallel to (or substantially parallel to) the bait supporting section 270A. The locking section 270B and the transition section 270C may be included in the hook portion 220 of the bait bar 150.

The locking channel 240 of the locking mechanism 230 may receive the locking section 270B of the bait rod 150. The transition section 270C may extend between the bait support section 270A and the locking section 270B. The locking section 270B may be laterally offset from the bait support section 270A, for instance because the transition section 270C laterally offsets the locking section 270B from the bait support section 270A. Laterally offsetting the locking section 270B may facilitate alignment of the locking section 270B with the locking channel 240, for instance when the bait rod 150 is pivoted with respect to the chassis 110. The locking section 270B may be retained in the locking channel 140, for example by engaging with the ridge 260 of the tab 250. Accordingly, the bait bar 150 may be secured to the chassis 110 of the bait pest control device 100.

The bait support system 200 may provide an improvement over designs that require a lid (e.g., the lid 140, as shown in FIG. 1) configured to lock a bait bar, such as designs where the lid is opened to release the bait bar and closed to clamp down on the bait bar or secure it within a pest control area. Such bait box designs are inferior because if the lid is separated from the remainder of the device, because the bait may be separated from the device (e.g., by a pest or other animal that may carry the bait away from the bait box). The present locking mechanism 230 secures the bait bar 150 to the chassis 110 to keep the bait 160 securely in place until the bait bar 150 is removed from the locking mechanism 230, even if the lid 140 is in the open configuration.

The locking mechanism 230 may cooperate with the bait bar receptacle 170 (shown in FIG. 1) to lock the bait bar 150 to the pest control device 100. For example, the first end 151 (shown in FIG. 1) of the bait bar 150 may be retained in the bait bar receptacle 170. Accordingly, the bait bar receptacle 170 may secure the first end 151 of the bait bar 150 to the chassis 110 of the pest control device 100. The bait bar 150 may be slidably coupled with the post 210. The post 210 may be located between the locking mechanism 230 and the bait bar receptacle 170 (shown in FIG. 1). The locking mechanism 230 may secure the second end 152 of the bait bar 150 to the chassis 110. Accordingly, the ends 151, 152 of the bait bar 150 are secured to the chassis 110, for instance when the lid 140 is in the open configuration.

### EXAMPLES

Example 1 is a pest control device, comprising: a bait support system disposed in an enclosure including a chassis and a lid, the bait support system including: a bait bar having a first end and a second end; a bait bar receptacle in the pest control device configured to receive at least a portion of the first end of the bait bar; a locking mechanism configured to secure the second end so as to lock the bait bar to the pest control device; and wherein the bait bar is secured to the pest control device using a locking mechanism operable to secure the bait bar independent of a position of the lid of the pest control device.

In Example 2, the subject matter of Example 1 optionally includes a post having an aperture, the post extending from the chassis, wherein the post is configured to receive at least a portion of the bait bar in the aperture.

In Example 3, the subject matter of any one or more of Examples 1-2 optionally include wherein the bait bar includes a locking portion proximal the second end, the locking portion adapted to engage with the locking mechanism.

In Example 4, the subject matter of Example 3 optionally includes wherein the first end of the bait bar is retained in the bait bar receptacle when the locking portion is engaged with the locking mechanism.

In Example 5, the subject matter of any one or more of Examples 3-4 optionally include wherein the locking portion of the bait bar includes a hook portion configured to lock the bait bar using the locking mechanism.

In Example 6, the subject matter of any one or more of Examples 1-5 optionally include wherein the bait bar is configured to pivot between a locked configuration and an unlocked configuration in the pest control device.

In Example 7, the subject matter of any one or more of Examples 1-6 optionally include wherein the bait bar includes: a bait support section disposed between the first end and the second end of the bait bar.

In Example 8, the subject matter of any one or more of Examples 1-7 optionally include wherein the locking mechanism includes a tab with a ridge to releasably engage at least a portion of the bait bar proximal the second end.

In Example 9, the subject matter of any one or more of Examples 1-8 optionally include a molded chassis including the bait bar receptacle and the locking mechanism; and a post configured to hold the bait bar near the second end and to allow for the bait bar to engage with the locking mechanism.

Example 10 is a pest control device, comprising: a chassis; a bait support system including: a bait bar having a first end and a second end, wherein the second end includes a hook portion; a bate bar receptacle in the chassis configured to receive at least a portion of the first end of the bait bar; a locking mechanism configured to receive the hook portion and secure the second end so as to lock the bait bar to the chassis; and wherein the bait bar is configured to pivot between a locked configuration and an unlocked configuration, wherein: in the locked configuration, the hook portion of the bait bar is received in the locking mechanism to inhibit movement of the bait rod with respect to the chassis; and in the unlocked configuration, the hook portion of the bait bar is disengaged from the locking mechanism and the second end of the bait bar is allowed to move relative to the chassis.

In Example 11, the subject matter of any one or more of Examples 1-10 optionally includes wherein the bait bar is locked to the pest control device when a lid of the pest control device is in an open configuration.

In Example 12, the subject matter of any one or more of Examples 10-11 optionally include a bait bar receptacle configured to receive and retain the first end of the bait bar, and a post extending from a device chassis of the pest control device near the locking mechanism, such that when the first end is disposed in the bait bar receptacle and the second end is secured by the post and the locking mechanism in a locked configuration.

In Example 13, the subject matter of Example 12 optionally includes wherein the bait bar includes: a bait support section; a locking section offset from the bait support section, the locking section of the bait bar configured for reception by the mechanism; a transition section extending between the bait support section and the locking section, the transition section providing the offset to the locking section of the bait bar.

In Example 14, the subject matter of Example 13 optionally includes a post extending from the pest control device and including an aperture disposed in the post.

In Example 15, the subject matter of Example 14 optionally includes wherein the bait bar slidably couples with the with the post to inhibit separation of the bait bar from the post when the bait bar is received in the aperture.

In Example 16, the subject matter of any one or more of Examples 14-15 optionally include wherein the post is configured to hold the bait bar near the second end and to allow for the bait bar to engage with the locking mechanism.

In Example 17, the subject matter of any one or more of Examples 1-16 optionally include wherein the bait bar is metal and the chassis is plastic.

Example 18 is a method of operating a pest control device having an enclosure, comprising: inserting a first end of a bait bar into a first aperture of a post; positioning bait on the bar before sliding the first end of the bait bar into a bait bar receptacle; and rotating the bait bar to engage a second end of the bait bar with a locking mechanism of the pest control device.

In Example 19, the subject matter of Example 18 optionally includes after positioning bait on the bait bar, inserting the first end of the bait bar into the bait bar receptacle.

In Example 20, the subject matter of any one or more of Examples 18-19 optionally include replacing bait on the bait bar by disengaging the second end of the bait bar from the locking mechanism; sliding the first end of the bait bar out of the bait bar receptacle; replacing bait on the bait bar; inserting the first end of the bait bar into the bait bar receptacle; and rotating the bait bar to engage a second end of the bait bar with a locking mechanism of the pest control device.

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the inventors also contemplate examples in which only those elements shown or described are provided.

In this document, the terms “a” or “an” are used, as is common in patent documents, to include one or more than one, independent of any other instances or usages of “at least one” or “one or more.” In the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description.

What is claimed is:

1. A pest control device, comprising:
a bait support system disposed in an enclosure including a chassis and a lid, the bait support system including:
a bait bar having a first end and a second end;
a bait bar receptacle in the pest control device configured to receive at least a portion of the first end of the bait bar;
a locking mechanism configured to secure the second end so as to lock the bait bar to the pest control device; and
wherein the bait bar is secured to the pest control device using a locking mechanism operable to secure the bait bar independent of a position of the lid of the pest control device.

2. The pest control device of claim 1, further comprising a post having an aperture, the post extending from the chassis, wherein the post is configured to receive at least a portion of the bait bar in the aperture.

3. The pest control device of claim 1, wherein the bait bar includes a locking portion proximal the second end, the locking portion adapted to engage with the locking mechanism.

4. The pest control device of claim 3, wherein the first end of the bait bar is retained in the bait bar receptacle when the locking portion is engaged with the locking mechanism.

5. The pest control device of claim 3, wherein the locking portion of the bait bar includes a hook portion configured to lock the bait bar using the locking mechanism.

6. The pest control device of claim 1, wherein the bait bar is configured to pivot between a locked configuration and an unlocked configuration in the pest control device.

7. The pest control device of claim 1, wherein the bait bar includes:
a bait support section disposed between the first end and the second end of the bait bar.

8. The pest control device of claim 1, wherein the locking mechanism includes a tab with a ridge to releasably engage at least a portion of the bait bar proximal the second end.

9. The pest control device of claim 1, comprising:
a molded chassis including the bait bar receptacle and the locking mechanism; and
a post configured to hold the bait bar near the second end and to allow for the bait bar to engage with the locking mechanism.

10. A pest control device, comprising:
a chassis;
a bait support system including:
a bait bar having a first end and a second end, wherein the second end includes a hook portion;
a bate bar receptacle in the chassis configured to receive at least a portion of the first end of the bait bar;
a locking mechanism configured to receive the hook portion and secure the second end so as to lock the bait bar to the chassis; and
wherein the bait bar is configured to pivot between a locked configuration and an unlocked configuration, wherein:
in the locked configuration, the hook portion of the bait bar is received in the locking mechanism to inhibit movement of the bait rod with respect to the chassis; and
in the unlocked configuration, the hook portion of the bait bar is disengaged from the locking mechanism and the second end of the bait bar is allowed to move relative to the chassis.

11. The pest control device of claim 10, wherein the bait bar is locked to the pest control device when a lid of the pest control device is in an open configuration.

12. The pest control device mounting system of claim 10, further comprising a bait bar receptacle configured to receive and retain the first end of the bait bar, and a post extending from a device chassis of the pest control device near the locking mechanism, such that when the first end is disposed in the bait bar receptacle and the second end is secured by the post and the locking mechanism in a locked configuration.

13. The pest control device mounting system of claim 12, wherein the bait bar includes:
a bait support section;
a locking section offset from the bait support section, the locking section of the bait bar configured for reception by the mechanism;
a transition section extending between the bait support section and the locking section, the transition section providing the offset to the locking section of the bait bar.

14. The pest control device of claim 13, further comprising a post extending from the pest control device and including an aperture disposed in the post.

15. The pest control device of claim 14, wherein the bait bar slidably couples with the with the post to inhibit separation of the bait bar from the post when the bait bar is received in the aperture.

16. The pest control device of claim 14, wherein the post is configured to hold the bait bar near the second end and to allow for the bait bar to engage with the locking mechanism.

17. The pest control device of claim 1, wherein the bait bar is metal and the chassis is plastic.

18. A method of operating a pest control device having an enclosure, comprising:
inserting a first end of a bait bar into a first aperture of a post;
positioning bait on the bar before sliding the first end of the bait bar into a bait bar receptacle; and
rotating the bait bar to engage a second end of the bait bar with a locking mechanism of the pest control device.

19. The method of claim 18, further comprising:
after positioning bait on the bait bar, inserting the first end of the bait bar into the bait bar receptacle.

20. The method of claim 18, further comprising:
replacing bait on the bait bar by disengaging the second end of the bait bar from the locking mechanism;
sliding the first end of the bait bar out of the bait bar receptacle;
replacing bait on the bait bar;
inserting the first end of the bait bar into the bait bar receptacle; and
rotating the bait bar to engage a second end of the bait bar with a locking mechanism of the pest control device.
